(19) United States
(12) Patent Application Publication
(10) Pub. No.: US 2024/0126257 A1
(43) Pub. Date: Apr. 18, 2024

(54) VEHICLE CONTROL SYSTEM, VEHICLE CONTROL METHOD, AND VEHICLE CONTROL PROGRAM

(71) Applicant: TOYOTA JIDOSHA KABUSHIKI KAISHA, Toyota-shi (JP)

(72) Inventors: Hiromitsu URANO, Numazu-shi (JP); Takefumi Goto, Gotemba-shi (JP); Hiromitsu Kobayashi, Nagoya-shi (JP)

(73) Assignee: TOYOTA JIDOSHA KABUSHIKI KAISHA, Toyota-shi (JP)

(21) Appl. No.: 18/464,920

(22) Filed: Sep. 11, 2023

(30) Foreign Application Priority Data
Oct. 17, 2022 (JP) 2022-166358

(51) Int. Cl. G05D 1/00; B60W 60/00

(52) U.S. Cl. CPC G05D 1/0022; B60W 60/001; B60W 2556/45; G05D 2201/0213

(57) ABSTRACT

The vehicle control system, in response to transmission of a command from a remote assistance apparatus to a vehicle, sets a cancellable period during which the command can be cancelled by the remote assistance apparatus. Also, the vehicle control system acquires a communication delay time between the vehicle and the remote assistance apparatus. The vehicle control system adjusts a control amount of the vehicle related to a speed in accordance with the communication delay time on condition that current time is within the cancellable period and the communication delay time is equal to or greater than a predetermined time.

### CROSS-REFERENCE TO RELATED APPLICATION

The present application claims priority under 35 U.S.C. § 119 to Japanese Patent Application No. 2022-166358, filed Oct. 17, 2022, the contents of which application are incorporated herein by reference in their entirety.

### BACKGROUND

### Field

The present disclosure relates to a system, a method, and a program for controlling a vehicle provided with remote assistance using wireless communication from a remote assistance apparatus.

### Background Art

JP2019-087015A, JP6940036B, JP2020-042643A, and JP2016-071585A can be exemplified as documents showing the technical level of the technical field related to the present disclosure. For example, JP2019-087015A discloses a system in which when an autonomous vehicle detects an obstacle, the autonomous vehicle automatically stops and communicates with a remote center, and when the remote center determines that the autonomous vehicle may resume traveling, the remote center transmits a start signal to the autonomous vehicle.

### SUMMARY

Meanwhile, in the remote assistance of the vehicle using the wireless communication by a remote assistance apparatus, it is desirable to cancel a command transmitted from the remote assistance apparatus to the vehicle for a predetermined time after the command is transmitted. However, when a communication delay occurs between the remote assistance apparatus and the vehicle, the notification of the cancellation of the command is not immediately transmitted to the vehicle, and thus the vehicle cannot stop the execution of the command.

The present disclosure has been made in view of the above problem. An object of the present disclosure is to enable cancellation of a command transmitted from a remote assistance apparatus to a vehicle even in a situation in which a communication delay occurs in remote assistance of the vehicle using wireless communication by the remote assistance apparatus.

The present disclosure provides a system for achieving the above object. The system of the present disclosure is a system for controlling a vehicle provided with remote assistance using wireless communication from a remote assistance apparatus. The system of the present disclosure includes at least one processor and a program memory coupled to the at least one processor and storing a plurality of instructions. The plurality of instructions is configured to cause the at least one processor to execute the following first to third processes. The first process is a process of, in response to transmission of a command from the remote assistance apparatus to the vehicle, setting a cancellable period during which the command can be cancelled by the remote assistance apparatus. The second process is a process of acquiring a communication delay time between the vehicle and the remote assistance apparatus. The third process is a process of adjusting a control amount of the vehicle related to a speed in accordance with the communication delay time on condition that current time is within the cancellable period and the communication delay time is equal to or greater than a predetermined time.

Also, the present disclosure provides a program for achieving the above object. The program of the present disclosure is a program storable in a non-transitory computer-readable storage medium and includes a plurality of instructions configured to cause at least one processer to execute the above-described first to third processes.

Further, the present disclosure provides a method for achieving the above object. The method of the present disclosure is a method for controlling a vehicle provided with remote assistance using wireless communication from a remote assistance apparatus. The method of the present disclosure includes the following first to third steps. The first step is a step of, in response to transmission of a command from the remote assistance apparatus to the vehicle, setting a cancellable period during which the command can be cancelled by the remote assistance apparatus. The second step is a step of acquiring a communication delay time between the vehicle and the remote assistance apparatus. The third step is a step of adjusting a control amount of the vehicle related to a speed in accordance with the communication delay time on condition that current time is within the cancellable period and the communication delay time is equal to or greater than a predetermined time.

According to the technique of the present disclosure, in a case where a communication delay in which the communication delay time is equal to or greater than the predetermined time occurs, if the current time is within the cancellable period in which the command can be cancelled by the remote assistance apparatus, the control amount of the vehicle related to the speed is adjusted in accordance with the communication delay time. This makes it possible to make full use of the cancellable period and to have room to cancel the command transmitted from the remote assistance apparatus to the vehicle even in a situation where there is a delay in the communication.

### BRIEF DESCRIPTION OF THE DRAWINGS

FIG. 1 is a diagram illustrating a vehicle control method according to an embodiment of the present disclosure.

FIG. 2 is a diagram illustrating a vehicle control method according to an embodiment of the present disclosure.

FIG. 3 is a flowchart illustrating a procedure of a vehicle control method according to an embodiment of the present disclosure.

FIG. 4A is a graph showing a method of adjusting accelerations as controlled variables of the car.

FIG. 4B is a graph showing a method of adjusting accelerations as controlled variables of the car.

FIG. 4C is a graph showing a method of adjusting accelerations as controlled variables of the car.

FIG. 5 is a functional block diagram illustrating a configuration of a vehicle control system according to an embodiment of the present disclosure.

FIG. 6A is a block diagram showing a configuration of an autonomous driving car.

FIG. 6B is a block diagram showing a configuration of the remote assistance apparatus.

### DETAILED DESCRIPTION

### 1. Vehicle Control Method

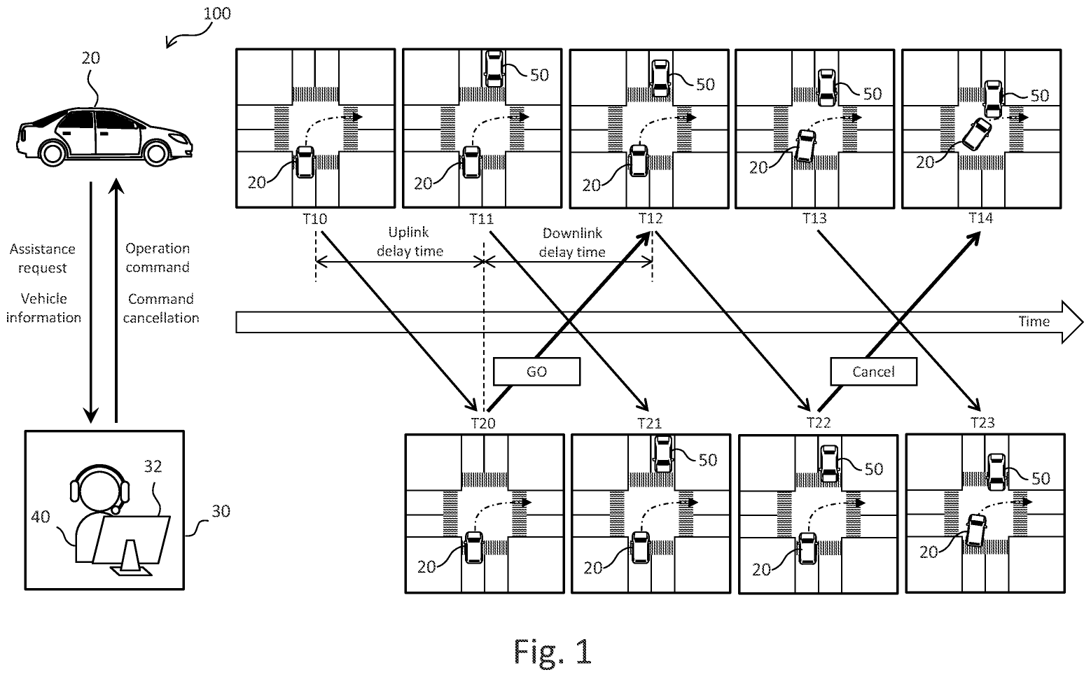

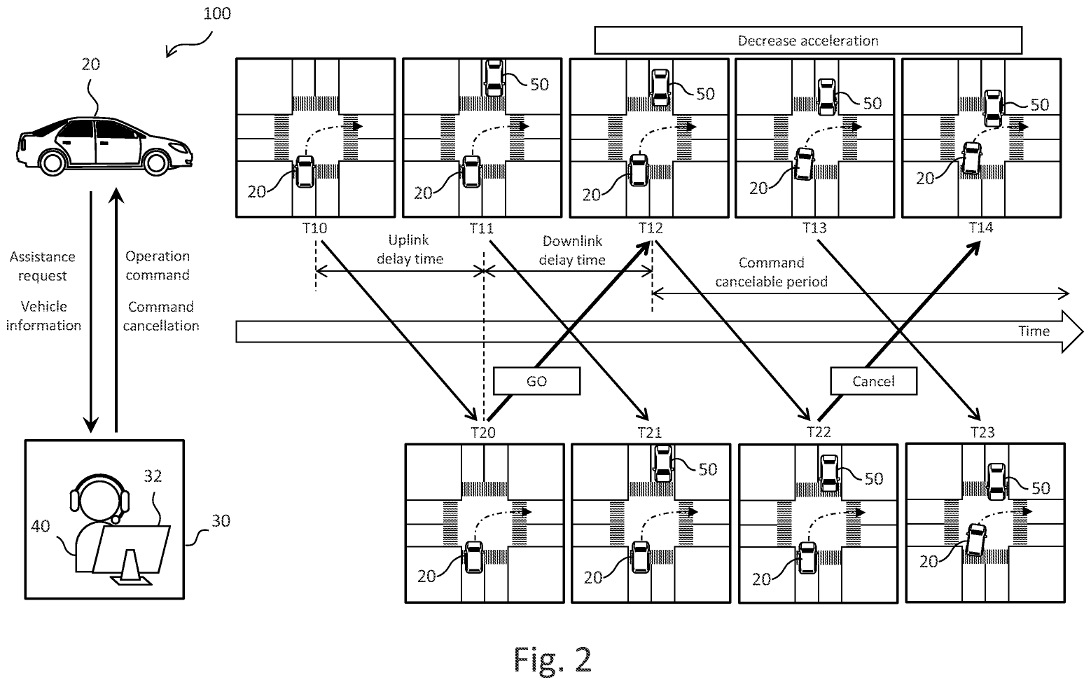

FIGS. 1 and 2 are diagrams illustrating a vehicle control method according to the present embodiment. The vehicle control method according to the embodiment is implemented in the remote assistance system 100. The remote assistance system 100 is a system in which an operator 40 at a remote place supports automatic driving of an automatic driving vehicle 20 having an autonomous traveling function by using wireless communication. For example, level 4 or level 5 is assumed as the autonomous driving level of the autonomous driving vehicle 20 which is the target of the remote assistance. Hereinafter, the autonomous driving vehicle 20 is simply referred to as the vehicle 20. The remote assistance apparatus 30 is used for remote assistance of the vehicle 20 by the operator 40. The remote assistance apparatus 30 is connected to the vehicle 20 via a wireless network. However, the remote assistance apparatus 30 and the vehicle 20 may be connected via a server.

The support request as a trigger of the remote assistance is transmitted from the vehicle 20. The situation in which the vehicle 20 transmits the assistance request includes, for example, a case where the vehicle 20 passes through a crosswalk, a case where the vehicle 20 turns right at an intersection, and the like. In the remote assistance, at least a part of the determination for the autonomous driving by the vehicle 20 is performed by the operator 40. Basic calculations related to perception, judgment, and operation required for driving are performed in the vehicle 20.

When the remote assistance is requested from the vehicle 20, information on the peripheral situation of the vehicle 20 including an image of the front of the vehicle 20 captured by the in-vehicle camera is transmitted from the vehicle 20 to the remote assistance apparatus 30. The operator 40 determines an action to be taken by the vehicle 20 while checking the peripheral situation of the vehicle 20 displayed on the display device 32 of the remote assistance apparatus 30, and transmits a command to the vehicle 20 based on the determination result. The command transmitted from the remote assistance apparatus 30 to the vehicle 20 includes, for example, a command to start the vehicle 20 at an intersection or a crosswalk.

The command transmitted from the remote assistance apparatus 30 to the vehicle 20 can be cancelled. The operator 40 can cancel the previously transmitted command by transmitting a command cancellation signal from the remote assistance apparatus 30 to the vehicle 20. The cancellation of the command can be performed not only before the vehicle 20 takes an action according to the command but also after the vehicle 20 takes an action according to the command. Examples of the situation in which the command is cancelled include a situation in which the surrounding situation of the vehicle 20 has changed more than expected from the situation at the time of transmission of the command.

However, as long as the wireless network is used, some communication delay always occurs between the vehicle 20 and the remote assistance apparatus 30. The magnitude of communication delay sometimes affects the success or failure of remote assistance. Hereinafter, the influence of the communication delay on the success or failure of the remote assistance and a vehicle control method capable of reducing the influence will be described with reference to FIGS. 1 and 2.

FIG. 1 shows a driving support result by the remote assistance system 100 when the vehicle control method according to the present embodiment is not used, and FIG. 2 shows a driving support result by the remote assistance system 100 when the vehicle control method according to the present embodiment is used. In both FIGS. 1 and 2, a situation is assumed in which the vehicle 20 is about to turn right at the intersection and another vehicle 50 (referred to herein as another vehicle) is entering the intersection from the opposite lane.

In the upper part of each of FIGS. 1 and 2, an image diagram showing the positional relationship between the vehicle 20 and the other vehicle 50 recognized from the image of the camera of the vehicle 20 is drawn. These image diagrams correspond to plan views obtained by converting camera images. The five image diagrams shown in the upper part are all different in time, and are arranged in time series from left to right in the order of time T10, T11, T12, T13, T14. However, the image captured by the camera of the vehicle 20 is a moving image, and the positional relationship between the vehicle 20 and the other vehicle 50 is also recognized in a continuous flow of time. Here, the positional relationship at a specific time in the continuous time is merely picked up and shown.

An image diagram showing the positional relationship between the vehicle 20 and the other vehicle 50 spatially projected on the screen of the display device 32 of the remote assistance apparatus 30 is depicted in the lower part of each of FIGS. 1 and 2. These image diagrams correspond to plan views converted from the 3D images displayed on the display unit 32. The four image diagrams shown in the lower part are all different in time, and are arranged in time series from left to right in the order of time T20, T21, T22, T23. However, the image displayed on the screen of the display device 32 is a moving image, and the positional relationship between the vehicle 20 and the other vehicle 50 in the screen continuously changes with time. Here, the positional relationship at a specific time in the continuous time is merely picked up and shown.

First, a driving support result when the vehicle control method according to the present embodiment is not used will be described with reference to FIG. 1. In the example shown in FIG. 1, the assistance requested by the vehicle 20 is to determine whether or not to make a right turn at the intersection into which the vehicle 20 has entered. The vehicle 20 temporarily stops before turning right, and waits until a transmission command is transmitted from the remote assistance apparatus 30. At the time T10, the other vehicles have not approached the intersection in the opposite lane. The video transmitted from the car 20 at the time T10 is displayed on the display 32 at the time T20. The time T10 and the time T20 do not coincide with each other, and there is a delay time between the time T10 and the time T20. The delay time in the upstream direction is called an upstream delay time.

The operator 40 determines from the image displayed on the display unit 32 at the time T20 that the car 20 can turn right, and instructs the car 20 to start (Go). The command transmitted from the remote assistance apparatus 30 at the time T20 is executed by the car 20 at the time T12. The time T20 and the time T12 do not coincide with each other, and there is a delay time between the time T20 and the time T12. The delay time in the downstream direction is called a downstream delay time.

Due to the presence of the up delay time and the down delay time, the surrounding situation of the vehicle 20 when the operator 40 commands the start may be significantly different from the surrounding situation of the vehicle 20 when the command is executed by the vehicle 20. In the example shown in FIG. 1, the other vehicles 50 are about to enter the intersection at time T12 when the command is executed by the vehicles 20. Such a situation may occur when the other vehicles 50 approach the intersection at a speed that was not assumed at the time point of T10.

The operator 40 notices the entry of the other car 50 into the intersection at the time T22 when the image transmitted from the car 20 at the time T12 is displayed on the display 32. There is also an upstream delay time between time T12 and time T22.

When it is determined that it is difficult for the vehicle 20 to make a right turn from the positional relationship between the vehicle 20 and the other vehicle 50 displayed on the display device 32, the operator 40 cancels the command to start the vehicle 20. However, the command cancellation signal transmitted from the remote assistance apparatus 30 at time T22 reaches the vehicle 20 at time T14. There is also a downstream delay time between time T22 and time T14.

Due to the presence of the up delay time and the down delay time, the peripheral situation of the vehicle 20 at the time when the operator 40 cancels the start command may be significantly different from the peripheral situation of the vehicle 20 at the time when the command cancellation signal arrives at the vehicle 20. In the example shown in FIG. 1, at time T14 at which the command cancellation signal arrives at the car 20, the other car 50 has entered the intersection greatly, and the car 20 has already advanced to the vicinity of the center of the intersection. It takes a certain period of time and a certain braking distance until the vehicle 20 that has received the cancellation of the command stops. Therefore, in the example illustrated in FIG. 1, the cancellation of the command is not in time for the change in the relative position between the vehicle 20 and the other vehicle 50, and there is a possibility that a danger occurs between the vehicle 20 and the other vehicle 50 or a possibility that the traffic flow is disturbed by the vehicle 20.

Next, a driving support result when the vehicle control method according to the present embodiment is not used will be described with reference to FIG. 2. Also in the example illustrated in FIG. 2, the vehicle 20 temporarily stops before the right turn, and waits until a command for transmission is transmitted from the remote assistance apparatus 30. At the time T10, the other vehicles have not approached the intersection in the opposite lane. The video transmitted from the car 20 at the time T10 is displayed on the display 32 at the time T20. As in the example shown in FIG. 1, the time T20 is delayed from the time T10 by the upstream delay time.

The operator 40 instructs the car 20 to start (Go) at the time T20. The command transmitted from the remote assistance apparatus 30 at the time T20 is executed by the car 20 at the time T12. As in the example shown in FIG. 1, the time T12 is delayed from the time T20 by the upstream delay time.

According to the vehicle control method of the present embodiment, a predetermined period from the time T12 at which the vehicle 20 receives the command from the remote assistance apparatus 30 is set as the command cancellable period for enabling cancellation of the command. The setting of the command cancellable period will be described in detail later. Then, within the command cancellable period, the control amount of the vehicle 20 related to the speed is adjusted in accordance with the magnitude of the delay time that is actually occurring. The delay time may be an uplink delay time, a downlink delay time, or a total time of both. In the example shown in FIG. 2, with the occurrence of the delay time, the acceleration after the start is made lower than usual.

The video transmitted from the car 20 at the time T12 is displayed on the display 32 at the time T22. As in the example shown in FIG. 1, the time T22 is delayed from the time T12 by the upstream delay time. The operator 40 cancels the start command to the car 20 at the time T22. The command cancellation signal transmitted from the remote assistance apparatus 30 at time T22 reaches the car 20 at time T14. As in the example shown in FIG. 1, the time T14 is delayed from the time T22 by the downlink delay time.

As described above, also in the example shown in FIG. 2, a delay time corresponding to the total time of the uplink delay time and the downlink delay time occurs between the time T12 at which the transmission command arrives at the car 20 and the time 14 at which the command cancellation signal arrives at the car 20. During the delay time, the other vehicle 50 enters the intersection and the vehicle 20 also moves forward. However, in the example shown in FIG. 2, since the acceleration of the vehicle 20 during the command cancellable period is suppressed to be low, the distance that the vehicle 20 travels after receiving the command to start is short. Therefore, in the example shown in FIG. 2, the cancellation of the command is in time for the change in the relative position between the vehicle 20 and the other vehicle 50, and the occurrence of danger between the vehicle 20 and the other vehicle 50 and the disturbance of the traffic flow are avoided.

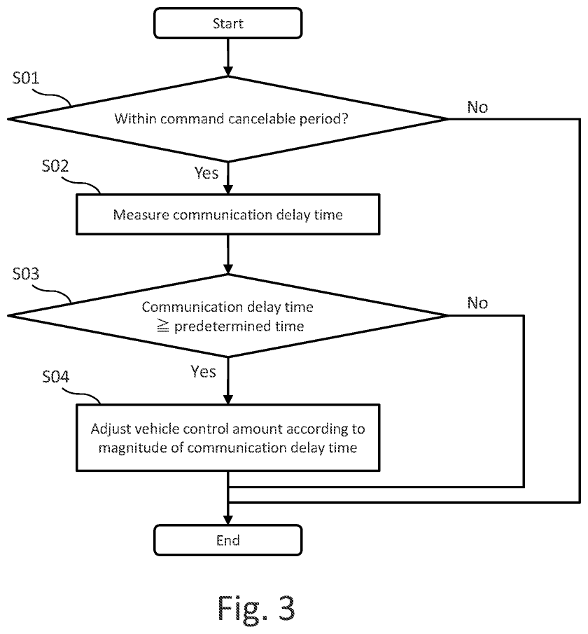

The procedure of the vehicle control method according to the present embodiment applied to the example shown in FIG. 2 can be shown by a flowchart. FIG. 3 is a flowchart illustrating a procedure of the vehicle control method according to the present embodiment. As shown in FIG. 3, the vehicle control method according to the present embodiment includes four steps.

Step S01 is executed in response to a command transmitted from the remote assistance apparatus 30 to the car 20. In step S01, it is determined whether or not the current time point is within the period in which the command can be cancelled, that is, within the command cancellable period. The command cancellable period also includes its start time. If the current time point is not within the command cancellable period, the subsequent steps are skipped and the control amount of the vehicle 20 is not adjusted.

If the determination result of step S01 is positive, the procedure proceeds to step S02. In step S02, the communication delay time is measured. A method of measuring the communication delay time will be described in detail later.

Next, in step S03, it is determined whether or not the communication delay time measured in step S02 is equal to or greater than a predetermined value. The predetermined value is a reference value for determining whether or not a communication delay occurs to such an extent as to affect the cancellation of the command. The predetermined value may be a fixed value or may be changed in accordance with a situation in which the vehicle 20 is placed. When the communication delay time is not equal to or greater than the predetermined value, the subsequent steps are skipped, and the control amount of the vehicle 20 is not adjusted.

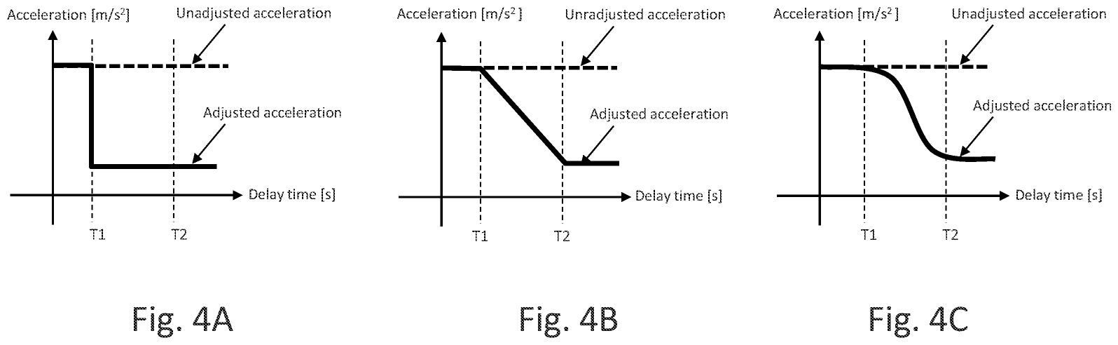

If the determination result of step S03 is positive, the procedure proceeds to step S04. In step S04, the control amount of the car 20 related to the speed is adjusted in accordance with the communication delay time. An example of the controlled variable to be adjusted is the acceleration described above. FIG. 4A, FIG. 4B, and FIG. 4C show examples of a method of adjusting accelerations as control amounts of the vehicles 20.

In the example shown in the 4A of the figure, the accelerations are adjusted stepwise. T1 in the graph is a predetermined value of the delay time used for the determination in step S03. The accelerations are not adjusted until the delay time reaches the T1. When the delay time becomes equal to or longer than the T1, the velocity is decreased to a certain adjusted velocity. Although the number of steps is one in the 4A of the drawing, the accelerations may be decreased in multiple steps of two or more steps.

In the example shown in the 4B of the figure, the accelerations are linearly adjusted according to the delay time. Also in this example, the accelerations are not adjusted until the delay time reaches the T1. Then, when the delay time becomes equal to or longer than the T1, the amount of decrease is linearly increased in accordance with an increase in the delay time. When the delay time is equal to or longer than the T2, the accelerations are adjusted to predetermined minimum values. This is because if the minimum value is not set for the acceleration, the vehicle 20 may move at a very low acceleration and disturb the traffic flow.

In the example shown in the 4C of the figure, the accelerations monotonically decrease with respect to the delay time and are nonlinearly adjusted in accordance with the delay time. Also in this example, the accelerations are not adjusted until the delay time reaches the T1. When the delay time is equal to or longer than the T2, the accelerations are adjusted to predetermined minimum values. Then, the acceleration is smoothly changed from the initial set value to the minimum value according to the increase of the delay time.

### 2. Vehicle Control System

Next, a vehicle control system according to the present embodiment will be described.

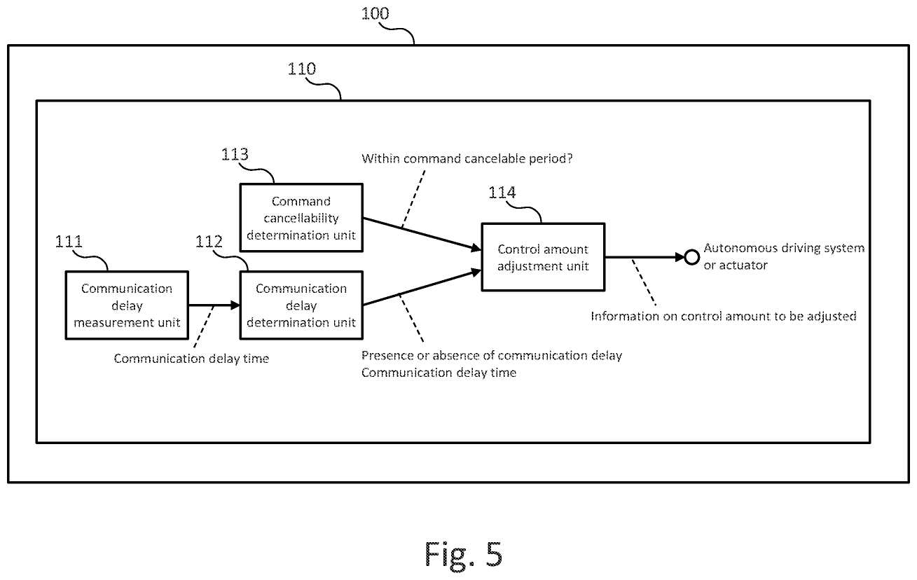

FIG. 5 is a functional block diagram showing the configuration of the vehicle control system according to the present embodiment. The vehicle control system 110 according to the present embodiment is a system that performs the above-described vehicle control method, and is included in the remote assistance system 100. The vehicle control system 110 includes a communication delay measurement unit 111, a communication delay determination unit 112, a command cancellation possibility determination unit 113, and a control amount adjustment unit 114. These are functions of the vehicle control system 110 that are realized by executing a plurality of predetermined commands by one or a plurality of processors physically configuring the vehicle control system 110.

The communication delay measurement unit 111 measures a communication delay time between the vehicle 20 and the remote assistance apparatus 30. For example, when it is assumed that the remote assistance system 100 is configured by a plurality of servers (hardware) and each function of automatic driving, remote assistance, and command cancellation is distributed to the plurality of servers, the following measurement method is conceivable.

The first method is a method in which the end-to-end time of one way from the vehicle 20 to the remote assistance apparatus 30 is measured and the measured time is used as the communication delay time.

The second method is a method in which the end-to-end time of the round trip from the vehicle 20 to the remote assistance apparatus 30 is measured and the measured time is used as the communication delay time. In this case, not only the uplink communication delay time required for uploading data from the vehicle 20 but also the downlink communication delay time required for downloading data to the vehicle 20 may be included.

A third method is a method in which a one way or round-trip time from the vehicle 20 to a certain server is measured and the measured time is used as the communication delay time. When the remote assistance system 100 includes a plurality of servers, a server causing a communication delay is not necessarily a server close to the remote assistance apparatus 30. It is considered that a very large communication delay occurs between the vehicle 20 and the window server serving as a window for the vehicle 20 due to the wireless communication. On the other hand, if the window server and the remote assistance apparatus 30 are present on the same network, communication can be performed with a very short delay time compared to communication between the vehicle 20 and the window server. For this reason, the communication delay time may be measured between the window server and the vehicle 20 instead of the remote assistance apparatus 30. If the load of the window server is high, the communication delay time may be measured by using another server on the same network as the window server.

A fourth method is a method in which a one way time from the vehicle 20 to a certain server A and a one way time from a certain server B to the vehicle 20 are respectively measured, and the total time thereof is set as the communication delay time. When the time variation width of the communication delay time is large, that is, when the dispersion is large, the time average thereof may be calculated and used as the communication delay time for communication delay determination.

The communication delay determination unit 112 determines, based on the communication delay time measured by the communication delay measurement unit 111, whether or not the currently occurring communication delay is a communication delay having a magnitude that affects the cancellation of the command. For example, in a case where the shortest communication delay is 0.1 seconds under an ideal environment in which high-speed communication is possible, 0.1 seconds may be set as, and it may be determined that there is no communication delay until 0.1 seconds. The communication delay determination unit 112 transmits the determination result and the communication delay time measured by the communication delay measurement unit 111 to the control amount adjustment unit 114 in the subsequent stage.

The command cancellation possibility determination unit 113 determines whether or not the current time point is within the command cancellable period in which the command can be cancelled. The command cancellable period is started from the time when the command is input to the vehicle 20. However, in order to prevent hunting, the command cancellable period may be started at a point in time when a certain period of time has elapsed since the command was input or at a point in time when the vehicle 20 has traveled a certain distance.

A time from the start can be set as the command cancellable period. A fixed value may be given to the time that defines the command cancellable period. For example, three seconds from the start time may be set as the command cancellable period. Also, a predetermined percentage of the time required to execute the command may be set as the command cancellable period. The time required for execution of the command means a time until passing through the intersection in the case of the remote assistance for passing through the intersection, and means a time until merging into the main line after starting in the case of the remote assistance for starting from the bus stop. For example, assuming that 50% of the time required to execute the command is the command cancellable period, when it is estimated that 10 seconds are required until the intersection is passed, the command cancellable period is 5 seconds from the start point.

It is also possible to set a distance from the start as the command cancellable period. The distance defining the command cancellable period may be given a fixed value. For example, a period from the start time to the 10 m of the car 20 may be set as the command cancellable period. Further, a predetermined ratio of the moving distance required for executing the command may be set as the command cancellable period. For example, assuming that 50% of the moving distance required for executing the command is the command cancellable period, when it is estimated that the 20 m travel is performed before passing through the intersection, the command cancellable period is from the start time point to the 10 m travel.

The command cancellable period can be changed according to the number of surrounding three dimensional objects. For example, when the number of three dimensional objects is equal to or less than a predetermined value, it is estimated that the possibility that the command is cancelled is low, and thus the command cancellable period may be shortened. On the other hand, if the number of solid objects is larger than the predetermined value, the command cancellable period may be extended. However, when the content of the remote assistance is the support for passing through the intersection, the maximum value of the command cancellable period may be set for each content of the support, for example, the maximum value of the command cancellable period may be set to the period until the vehicle 20 passes through the intersection.

Also, the command cancellable period can be changed according to the road structure. For example, the command cancellable period may be changed according to the complexity of the road structure such as the number of lanes, the presence or absence of a traffic signal, the road width, and the size of an intersection.

Further, the command cancellable period can be changed according to the communication state. For example, if it has been confirmed that the number of times of command cancellation is small when the communication state is good, the command cancellable period may be shortened as the communication state is good.

Note that only one command cancellable period is set for one remote assistance, and in some cases, a plurality of command cancellable periods may be set for one remote assistance. For example, assistance for departure from a bus stop includes two types of assistance, “door closing” and “departure OK”. Since the determination of the “door close” command and the determination of the “start OK” command are performed independently, the respective command cancellable periods may be set independently. A plurality of command cancellable periods may overlap with each other.

Also, the command cancellable period may be reset. For example, it is assumed that, in assistance for starting at an intersection, the number of surrounding three dimensional objects at the time when the start command is transmitted is 0, and thus the command cancellable period ends in three seconds. Thereafter, if a group of pedestrians appears at the intersection, the command cancellable period may be resumed in preparation for command retraction.

The command cancellable period may be displayed on the display device 32 of the remote assistance apparatus 30 so that the operator 40 can confirm the command cancellable period. Specifically, the remaining time of the command cancellable period may be superimposed and displayed on the camera image. The start time of the command cancellable period may also be displayed on the display device 32. The command cancellation possibility determination unit 113 transmits the determination result of the command cancellation possibility to the control amount adjustment unit 114 in the subsequent stage.

The control amount adjustment unit 114 adjusts the control amount of the vehicle 20 related to the speed according to the communication delay time on the condition that the current time point is within the command cancellable period and the communication delay time is equal to or greater than the predetermined value. Examples of the adjustable control amount include a maximum speed and a deceleration in addition to the acceleration. When the control amount is the maximum speed, the larger the communication delay time is, the lower the maximum speed is suppressed. When the control amount is the deceleration, the larger the communication delay time is, the higher the deceleration is set. In addition, a parameter that reduces the possibility of collision or damage with a moving body such as a pedestrian who has jumped out may be adjusted as a control amount. It is also possible to adjust the plurality of control amounts together.

The control amount adjustment unit 114 outputs information on the adjusted control amount to the subsequent stage. When the control amount adjustment unit 114 is provided in the remote assistance apparatus 30 or the server, the transmission destination of the adjusted control amount is the autonomous driving system of the vehicle 20. When the control amount adjustment unit 114 is provided in the vehicle 20, the transmission destination of the adjusted control amount is the actuator of the vehicle 20. It is not desirable that the motion of the vehicle 20 becomes unstable as a result of the adjustment of the control amount. Therefore, the time point at which the adjustment of the control amount is started may be reserved so that smooth traveling control of the vehicle 20 can be realized.

Finally, an example of a hardware configuration of the vehicle control system 110 will be described. The vehicle control system 110 may include the vehicle 20 and the remote assistance apparatus 30. Specifically, some or all of the functions of the vehicle control system 110 illustrated in FIG. 5 may be provided to the remote assistance apparatus 30, and the remaining functions of the vehicle control system 110 may be provided to the vehicle 20.

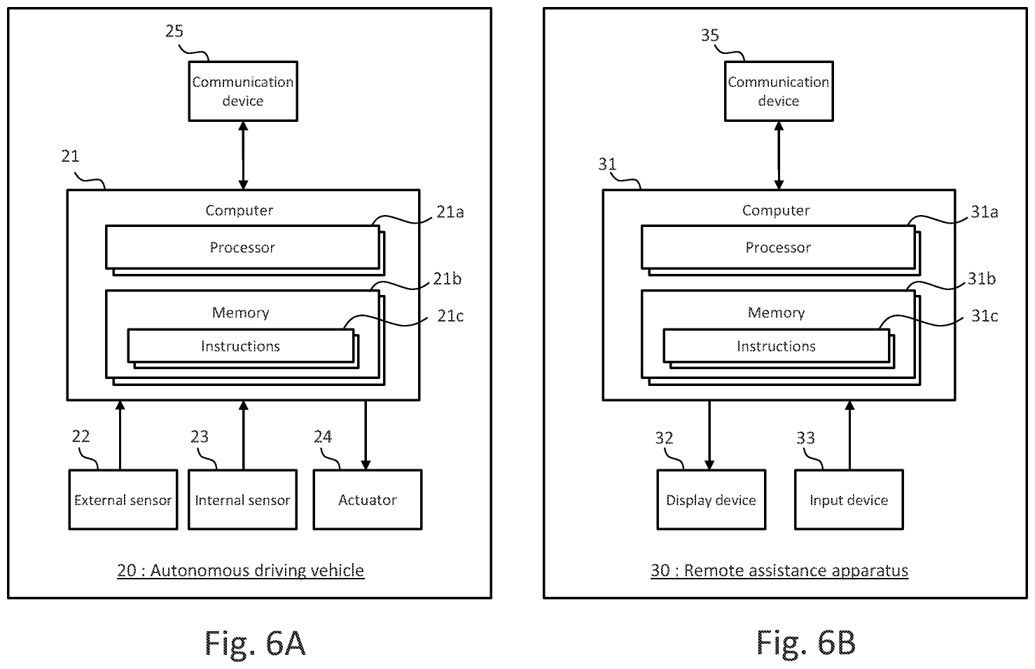

FIG. 6A is a block diagram showing an example of the configuration of the car 20. The vehicle 20 includes a computer 21. The computer 21 is an aggregate of a plurality of electronic control units (ECUs) mounted on the vehicle 20. The vehicle 20 includes an external sensor 22, an internal sensor 23, an actuator 24, and a communication device 25. These components are connected to the computer 21 using an in-vehicle network such as a controller area network (CAN).

The computer 21 comprises one or more processors 21a (hereinafter referred to simply as processor 21a) and one or more memories 21a (hereinafter referred to simply as memory 21b) coupled to the processor 21b. The memory 21b stores a plurality of instructions (programs) 21a executable by the processor 21c (hereinafter, simply referred to as an instruction 21c) and various pieces of information related thereto. The memory 21b stores high-precision three dimensional map information for automatic driving.

When the processor 21a executes the instruction 21c, various processes by the processor 21a are realized. The instruction 21c includes an instruction for realizing automatic driving. When the instruction is executed by the processor 21a, the computer 21 functions as an automatic driving system that automatically drives the car 20. The instruction 21c also includes an instruction for receiving remote assistance. When the instruction is executed by the processor 21a, a process for executing the command acquired from the remote assistance apparatus 30 in the vehicle 20 is executed. The instructions 21c also include instructions for causing the car 20 to function as part of the car control system 110.

The external sensor 22 is a sensor that acquires information for recognizing a situation around the vehicle 20. The external sensor 22 includes at least a camera that captures an image in front of the vehicle 20. The internal sensor 23 is a sensor that acquires information related to motion of the vehicle 20. The actuator 24 includes a steering device that steers the vehicle 20, a driving device that drives the vehicle 20, and a braking device that brakes the vehicle 20. The communication device 25 is a device that controls wireless communication between the vehicle 20 and the outside. The communication device 25 communicates with the server and the remote assistance apparatus 30 via a communication network.

FIG. 6B is a block diagram showing an example of the configuration of the remote assistance apparatus 30. The remote assistance apparatus 30 includes a computer 31, a display device 32, an input device 33, and a communication device 35. The display device 32, the input device 33, and the communication device 35 are connected to the computer 31.

The computer 31 comprises one or more processors 31a (hereinafter referred to simply as processor 31a) and one or more memories 31a (hereinafter referred to simply as memory 31b) coupled to the processor 21b. The memory 31b stores a plurality of instructions (programs) 31a executable by the processor 31c (hereinafter, simply referred to as an instruction 31c) and various pieces of information related thereto.

When the processor 31a executes the instruction 31c, various processes by the processor 31a are realized. The instruction 31c includes an instruction for managing a user interface for performing remote assistance for the vehicles 20. When the instruction is executed by the processor 31a, the computer 31 functions as an operator UI management system and executes processing for displaying information necessary for remote assistance on the display apparatus 32 described later. The instruction 31c also includes an instruction for causing the remote assistance apparatus 30 to function as a part or all of the vehicular control system 110.

The display device 32 is a device that displays information necessary for the operator 40 to perform remote assistance. The information displayed by the display device 32 includes an image in front of the vehicle 20 acquired by the camera of the vehicle 20. The input device 33 is a device for inputting an operation for remote assistance of the operator 40. The communication device 35 is a device that controls communication between the remote assistance apparatus 30 and the outside. The communication device 35 communicates with the server and the vehicle 20 via a communication network.

What is claimed is:

1. A system for controlling a vehicle provided with remote assistance using wireless communication from a remote assistance apparatus, the system comprising:
at least one processor; and
a program memory coupled to the at least one processor, the program memory storing a plurality of instructions configured to cause the at least one processor to execute:
in response to transmission of a command from the remote assistance apparatus to the vehicle, setting a cancellable period during which the command can be cancelled by the remote assistance apparatus;
acquiring a communication delay time between the vehicle and the remote assistance apparatus; and
adjusting a control amount of the vehicle related to a speed in accordance with the communication delay time on condition that current time is within the cancellable period and the communication delay time is equal to or greater than a predetermined time.

2. The system according to claim 1, wherein
the adjusting the control amount includes at least one of decreasing an acceleration of the vehicle, decreasing a maximum speed of the vehicle, and increasing a deceleration of the vehicle.

3. The system according to claim 1, wherein
the adjusting the control amount includes changing the control amount in accordance with the communication delay time until the vehicle starts, and fixing the control amount after the vehicle starts.

4. A method for controlling a vehicle provided with remote assistance using wireless communication from a remote assistance apparatus, the method comprising:
in response to transmission of a command from the remote assistance apparatus to the vehicle, setting a cancellable period during which the command can be cancelled by the remote assistance apparatus;
acquiring a communication delay time between the vehicle and the remote assistance apparatus; and
adjusting a control amount of the vehicle related to a speed in accordance with the communication delay time on condition that current time is within the cancellable period and the communication delay time is equal to or greater than a predetermined time.

5. A non-transitory computer-readable storage medium storing a program for controlling a vehicle provided with remote assistance using wireless communication from a remote assistance apparatus, the program comprising a plurality of instructions configured to cause at least one processor to execute:
in response to transmission of a command from the remote assistance apparatus to the vehicle, setting a cancellable period during which the command can be cancelled by the remote assistance apparatus;
acquiring a communication delay time between the vehicle and the remote assistance apparatus; and
adjusting a control amount of the vehicle related to a speed in accordance with the communication delay time on condition that current time is within the cancellable period and the communication delay time is equal to or greater than a predetermined time.
